(19) United States
(12) Patent Application Publication
(10) Pub. No.: US 2021/0029986 A1
(43) Pub. Date: Feb. 4, 2021

(54) Self-Climbing Platform

(71) Applicant: Luc Bouchard, Dolbeau-Mistassini (CA)

(72) Inventor: Luc Bouchard, Dolbeau-Mistassini (CA)

(21) Appl. No.: 16/526,517

(22) Filed: Jul. 30, 2019

(51) Int. Cl. A01M 31/02; E04G 3/32; E04G 5/14; A63B 27/00

(52) U.S. Cl. CPC A01M 31/02; E04G 3/32; E04G 2003/286; A63B 27/00; E04G 5/14

(57) ABSTRACT

A self-climbing platform adapted to movably attach to, and hang from, a vertical structure for supporting a load with a cable connected to a main support connector comprising a retaining strap configured to surround at least a portion of the vertical structure, an adjustment lock attached to the retaining strap and a bracket. The bracket comprising an upper member connecting on one side to an adjustment bar and to a second side of a lower member to form a triangulated structure configured to a cantilevered position with respect to the vertical structure. The cable supporting the platform is connected to the bracket in a manner permitting transmission of the force required to support the self-climbing platform in a direction angled towards the vertical structure. The platform can rotate 360° around a tree or pole and can be used in forestry, civil or recreational fields.

### CROSS-REFERENCE TO RELATED APPLICATIONS

There are no cross-related applications.

### FIELD OF THE INVENTION

The present invention essentially relates to the field of transportable and removable platforms for mounting on trees or poles for use in the civil industry, forestry or recreation among others. Specifically, the present invention relates to a means for securing a platform to a tree or a pole.

### SUMMARY OF THE INVENTION

The aforementioned objectives of the present invention are met using a new self-climbing platform.

This self-climbing platform essentially comprises, on the one hand, a main support including a winch for supporting the platform. It is supported by a cylindrical tree or pole and is supported by a 360° removable bracket located at a height higher than the platform.

This is an innovative self-climbing platform designed to be hoisted to a cylindrical element generally vertical to the ground. The platform enables one to climb to a tree or pole depending on the quality of the tree or pole. The self-climbing platform may include the following:
a platform to hold the user that can be grid-bottomed,
a main support for supporting the self-climbing platform,
a bracket connected to an adjustable retaining strap and two adjustment locks to hold the bracket in place on a tree or pole at an angle, allowing the self-climbing platform to hoist itself,
an electric winch with a steel cable connected by a carabiner to the bracket for supporting the platform,
a winder-unwinder tensioner with holding cable for stabilizing the platform during the ascent/descent along the tree or pole,
a self-locking safety system for holding the platform in a secured position against the tree of the pole,
adjustable support wheel for guiding the platform during the ascent/descent along the tree or poles, and
displacement skis facilitating the sliding of the platform along the tree or pole.

This self-climbing platform comprises a platform connected to a main support where a winch and a winder/unwinder provided with a holding cable are installed. The cable is attached to a bracket using a carabiner. The main support comprises a plate installed at the upper part of the platform and connected to the lower part via vertical supports.

The bracket is provided with a serrated plate allowing it to remain in the desired position and is fixed to the tree or pole with an angle which gives a safe advantage over the prior art.

The retaining strap with adjustment locks make it possible to manually slide the bracket around the tree or pole 360° degree to the desired position regardless of the diameter of the tree or pole. The pressure exerted on the bracket by the platform during the climb has the effect of increasing the pressure on the serrated plate and on the bracket.

The adjustable retaining strap and the two adjustment locks hold the bracket in place for different tree and poles sizes.

The purpose of the self-locking safety system is to avoid an unwanted descent when the platform is stopped. The self-locking security system may include a self-locking security lock, a lever and a resilient member that are connected to the main support.

The displacement skis can be integrated to the lower part of the platform and can facilitate the sliding of the platform on the tree or pole.

The self-climbing platform may include a removable seat being adapted to rotate 360° upon itself, or spin, on the platform. The seat is placed on a support allowing the user a freedom of movement of 360° either standing or sitting.

The self-climbing platform can be adapted to include a removable safety railing, three railing supports and two stabilizing cables. The railing supports and the stabilizing cables are connected to the removable safety railing.

Locking means keep the railing supports in place. The safety railing is intended to improve safety so as to prevent falls from the platform.

The self-climbing platform can also be adapted to include a battery to activate the winch.

The features of the present invention which are considered novel and inventive will be described in more detail in the claims presented hereinafter.

### BRIEF DESCRIPTION OF THE DRAWINGS

The above and other aspects, features and advantages of the invention will become more readily apparent from the following description, reference being made to the accompanying drawings in which:

FIG. 1 is an illustration of a perspective view of a self-climbing platform according to an embodiment of the present invention.

FIG. 2 is an illustration of a front view of a self-climbing platform according to an embodiment of the present invention.

FIG. 3 is an illustration of a side view of a self-climbing platform according to an embodiment of the present invention.

FIG. 4 is an illustration of a view above a self-climbing platform according to an embodiment of the present invention.

FIG. 5 is an enlarged illustration of the connector according to an embodiment of the present invention.

### DETAILED DESCRIPTION OF THE PREFERRED EMBODIMENT

A novel self-climbing platform will be described hereinafter. Although the invention is described in terms of specific illustrative embodiments, it is to be understood that the embodiments described herein are by way of example only and that the scope of the invention is not intended to be limited thereby.

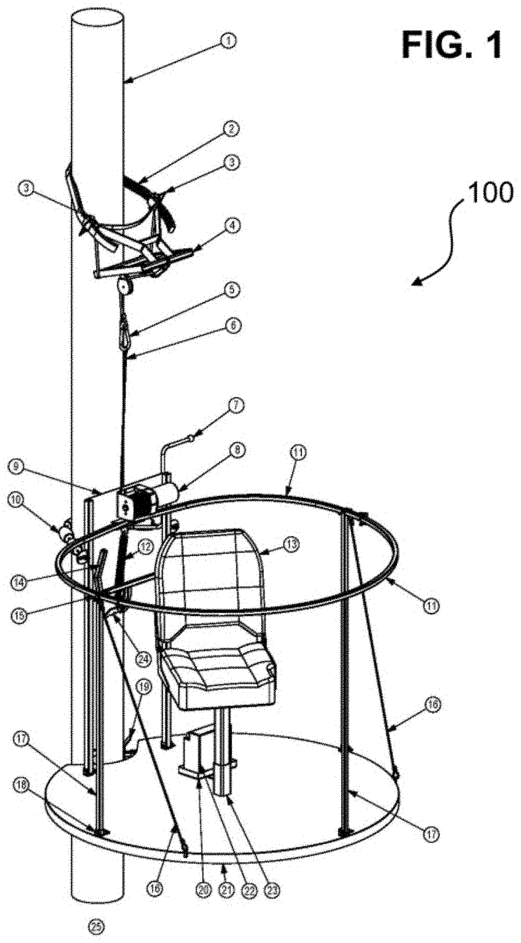

In one embodiment, a self-climbing platform 100 is illustrated (FIG. 1). The platform 100 may comprise, on the one hand, a main support 9, which may include a winch 8, for supporting the platform 21. The whole is supported on a tree or a pole 1 of generally cylindrical shape and is supported by a 360° removable bracket 4 located at a height higher than the platform.

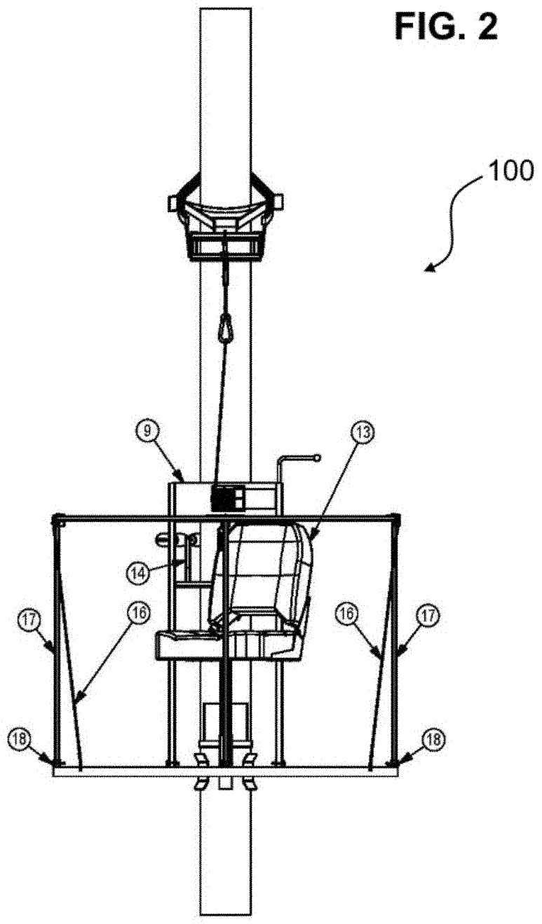

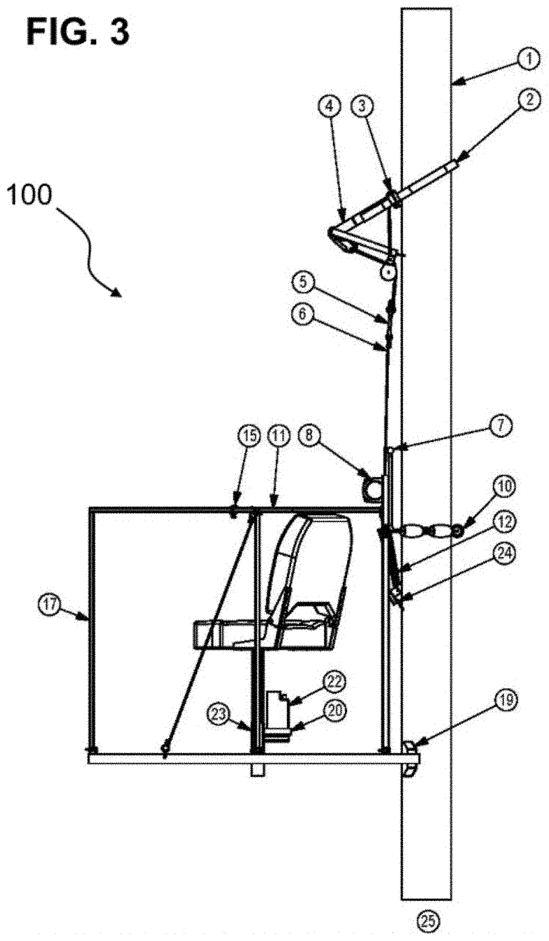

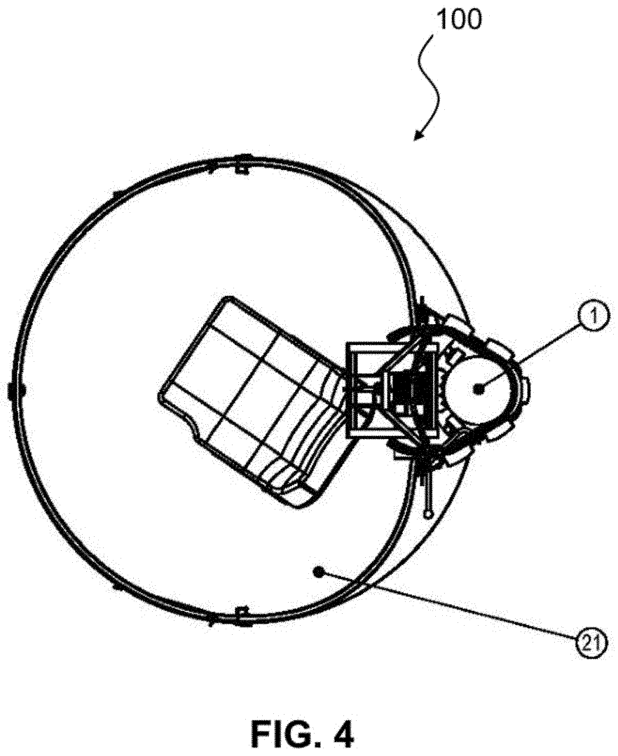

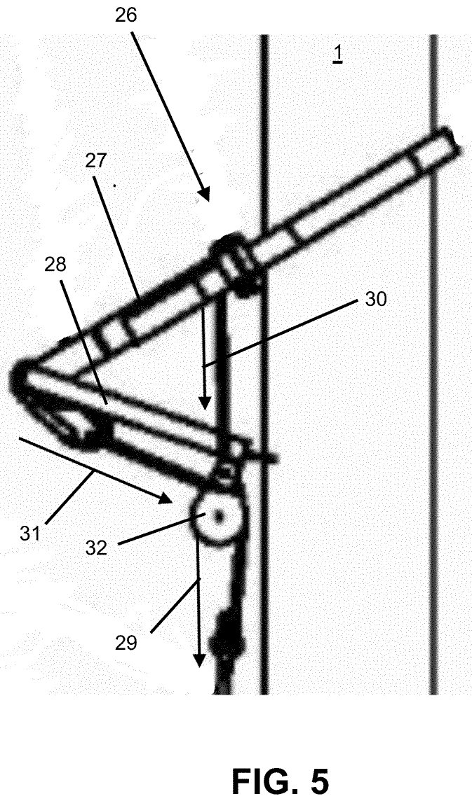

The self-climbing platform 100 generally allows climbing on a tree or pole depending on the quality of the tree or pole (1, FIG. 1). The self-climbing platform may include the following elements (FIG. 1):
a platform 21 (FIGS. 1 and 4) can be grid-bottomed,
a main support 9 (FIGS. 1 and 2),
a connector 26 (FIG. 5) and a bracket 4 (FIGS. 1 and 3) connected to an adjustable retaining strap 2 and two adjustment locks 3 (FIGS. 1 and 3) to hold the bracket in place with an angle,
an electric winch 8 (FIGS. 1 and 3) with a steel cable 6 (FIGS. 1 and 3) connected by a carabiner 5 (FIGS. 1 and 3) to the bracket 4,
a winder-unwinder tensioner with holding cable (FIGS. 1 and 3),
a self-locking security system 24,
adjustable support wheels 10 (FIGS. 1 and 3), and
displacement skis 19 (FIGS. 1 and 3).

It is a platform 21 connected to a main support 9 where a winch 8 and a winder/unwinder tensioner operatively connected to a steel cable 6, are installed on the main support 9. The steel cable 6 is attached to a bracket using a carabiner 5. The main support 9 comprises a plate installed at the top of the self-climbing platform 100 and connected to the platform 21 comprising the lower part of the platform through vertical supports. The capacity of the winch 8 may be about 2,000 lbs (907 kg).

The connector 26 comprises a retaining strap 2 configured to surround at least a portion of the tree or pole 1, an adjustment lock 3 attached to the retaining strap 2 and a bracket 4 comprising an upper chord 27 (FIG. 5) and a lower chord 28 (FIG. 5), the upper chord 27 connecting, on one side, to the adjustment bar 3 and, on the other side, to a second side of the lower chord 28 to form a triangulated structure, the bracket 4 being configured to a cantilever position with respect to the tree or the pole, the steel cable 6 supporting the platform 21 being connected to the bracket 4 in a manner for transmitting the force required to support the self-climbing platform in a generally angled direction 31 to the pole or tree 1 so as to engage the connector 26 with the tree or shaft 1 and prevent its sliding towards the Floor 25 (FIGS. 1 and 3). Indeed, the vertical tension 29 coming from the steel cable 6 is transmitted at an angle 31 by means of the pulley 32, integral with the upper 27 and lower 28 chords, which also applies a downward vertical tension on the connector 26. The connector 26 is thus configured to react vertically as well as at an angle 31 under the tension exerted by the steel cable 6.

The bracket 4 (FIGS. 2 and 3) is provided with a serrated plate allowing it to remain in the desired position and is fixed to the tree or pole 1 at an angle.

The retaining strap 2 (FIGS. 1 to 3) with adjustment locks 3 makes it possible to manually slide the bracket 4 around the pole or tree 1 over 360° at the desired position, whatever the diameter of the tree or pole. The pressure exerted on the bracket 4 by the platform 21 during the climb generally aims to increase the pressure on the serrated plate and on the bracket 4.

The adjustable retaining strap 2 and the two adjustment locks 3 generally allows the maintenance of the bracket in place on different sizes of poles or trees 1.

The self-locking safety system comprises a self-locking security lock 24 (FIGS. 1 and 3). The self-locking security lock 24 may also include a lever 14 (FIG. 1) and a spring 12 (FIGS. 1 and 3) which are connected to the main support for engaging and disengaging the self-locking security system 24. The self-locking security system 24 also optionally uses a second lever 7 to disengage the self-locking security system 24 by providing a double security. The self-locking safety system 24 generally aims to avoid an undesirable descent when stopping the platform.

In certain embodiments, the self-climbing platform 100 may also include a removable seat 13, and/or a removable safety railing 11, and/or a battery 22, and/or a cover.

In other embodiments, the displacement skis 19 are integrated with the platform 21 and facilitate the sliding of the platform on the tree or pole 1.

The self-climbing platform 100 may also include a removable seat 13 adapted to rotate 360°. The seat is placed on a support 23. The platform 100 generally provide the user with a freedom of movement of 360° either standing or sitting.

The self-climbing platform 100 can be adapted to include a removable safety railing 11 provided with a security lock 15. In some embodiments, the removable safety railing 11 is connected to the platform 21 by three railing supports 17 and two stabilizing cables 16. The railing supports 17 and the stabilizing cables are connected to the removable safety railing 11. Anchoring locks 18 can also keep the railing supports 17 in place. The railing supports 17 may be aimed at improving safety so as to prevent falls from the platform 100.

The self-climbing platform 100 may also include a battery 22. The battery 22 may be connected to the winch 8 to power it. This battery 22 may be 12 volts and may be installed on a support 20 placed above the platform. The battery 22 could also be positioned elsewhere, such as below the seat 13. The support 20 can be connected to the support of the seat 23. Of course, the platform 100 can be powered by other sources of currents, such as solar energy with the use of a solar panel. In some embodiments, the platform may include one or more power outlets, such as USB jacks.

In other embodiments, the platform 100 may be provided with a cover or canvas to position above the user of the platform 100, for example installed as an umbrella facing the weather. The cover can also be installed to surround the platform to protect the user and/or equipment.

The self-climbing platform 100 can be removable and transportable. The platform 100 can also be made of rigid materials, such as metal, aluminum, steel or other types of alloys. In general, the platform 100 is lightweight, removable and low volume. The platform 100 can also be used by people with reduced mobility.

Assembly and Operation

The components of the self-climbing platform 100 can be transported in transport bags or on a coupling of a small motorized vehicle. The platform 100 can be manufactured in such a way that the assembly and disassembly of the components of the platform 100 are carried out without any tools and/or in a simple manner.

The self-climbing platform 100 can be assembled according to the following steps: connect the platform 21 to the main support 9, connect the removable safety railing 11 and the railing supports 17 to the platform, and connect the steel cable 6 of the winch 8 to the carabiner 5 of the bracket 4.

Once the self-climbing platform 100 assembled, a user can access the platform 100 without the help of a ladder. The platform 100 can support high load at this time. The height at which the self-climbing platform 100 can be raised is adjustable according to the length of the steel cable 6 of the winch 8 and the quality of the anchoring, that is to say the quality of the pole or the tree 1.

Once the self-climbing platform 100 is brought near the tree or the pole 1, the bracket 4 is installed or anchored on the tree or pole 1 at the desired location, the height of the user. Once the bracket 4 is installed, the user can perform an action of ascent or descent.

The user can then activate the winch 8 to hoist the self-climbing platform 100 on the tree or pole 1. The ascent and descent are performed safely while being guided by the adjustable support wheels 10 as well as by the displacement skis 19. The adjustable support wheels 10 are adjusted according to the diameter of the tree or pole 1.

During the ascent of the self-climbing platform 100, the platform 100 rises until it is stopped by the user of the winch 8, the elevation being limited by the height of the bracket 4 on the tree or the pole 1. The movement is done using a winder-unwinder tensioner with a retaining strap, which passes through the adjustable support wheels 10, which aims to provide a stable and safe movement.

When stopping the self-climbing platform 100, the self-locking safety lock 24 is automatically deployed. The self-locking lock generally makes it possible to maintain the self-climbing platform 100 in the desired position on the tree or the pole.

During the descent of the platform 100, a double maneuver to initiate the descent can be performed for embodiments having a lever 14. The user must simultaneously activate the lever 14 (FIG. 2) of the self-locking security lock 24 (FIGS. 1 and 3) and activate the winch 8 to unwind the steel cable 6 to start the descent. As previously described, the self-locking safety system 24 optionally uses a second lever 7 to disengage the self-locking safety system 24. The second lever 7 must also be activated to initiate the descent as additional security measures.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A self-climbing platform adapted to movably attach to an essentially cylindrical and vertical structure, the self-climbing platform comprising:
a main support;
a platform connected to the main support, the platform forming a surface for supporting a load, the platform being adapted to hang from the vertical structure above the ground with a cable connected to a connector, the connector comprising:
a retaining strap configured to surround at least a portion of the vertical structure;
an adjustment lock attached to the retaining strap; and
a bracket comprising an upper member and a lower member, the upper member connecting, on one side, to the adjustment bar and to a second side of the lower member to form a triangulated structure , the bracket being configured to a cantilevered position with respect to the vertical structure, the cable supporting the platform being connected to the bracket in a manner permitting transmission of the force required to support the self-climbing platform in a direction angled towards the vertical structure so as to engage the connector with the vertical structure and prevent its sliding to the ground.

2. The self-climbing platform of claim 1, the cable being connected to the bracket by a bearing element.

3. The self-climbing platform of claim 1 in that the cable is connected to the main support for suspending the platform.

4. The self-climbing platform of claim 1, in that the cable is connected to the platform to suspend it.

5. The self-climbing platform of claim 1, in that the cable is connected to the platform with a winch for lifting and suspending the platform when the connector is engaged with the vertical structure.

6. The self-climbing platform of one of claim 1, in that the platform comprises a safety railing.

7. The self-climbing platform of one of claim 1, in that the platform comprises a seat.

8. The self-climbing platform of one of claim 1, in that the platform comprises at least one ski to slide along the vertical structure.

9. The self-climbing platform of claim 8, wherein the ski is configured to slide around the vertical structure and allow rotation of the platform around the vertical structure while suspended by the cable.

10. The self-climbing platform of one of claim 1, in that the self-climbing platform is temporarily fixed to the vertical structure using a security lock.

11. The self-climbing platform of claim 10, wherein the security lock is biased for a resilient member to engage the vertical structure.

12. The self-climbing platform of claim 11, the resilient member being a spring.

13. A method for assembling a connector to an essentially cylindrical and vertical structure to suspend a platform, the connector comprising:
a retaining strap configured to surround the vertical structure;
an adjustment lock attached to the retaining strap; and
a bracket comprising an upper member and a lower member, the upper member connecting, on one side, to the adjustment bar and, on the other side, to the second side of the lower member to form a triangulated structure, the bracket being configured to a cantilever position relative to the vertical structure, a cable configured to suspend the platform being adapted to be connected to the bracket,
the method comprising the steps:
applying a vertical downward force on the cable with the platform in a direction generally parallel to the vertical structure to suspend the platform with the cable;
altering the direction of application of at least a portion of the force transmitted by the cable in a direction angled to the vertical structure to engage the connector with the vertical structure.
